(19) United States
(12) Patent Application Publication
(10) Pub. No.: US 2025/0053931 A1
(43) Pub. Date: Feb. 13, 2025

(54) SYSTEM AND METHOD FOR AUTOMATIC CALENDARING

(71) Applicant: Capital One Services, LLC, McLean, VA (US)

(72) Inventors: Lee ADCOCK, Midlothian, VA (US); Mehulkumar Jayantilal GARNARA, Glen Allen, VA (US); Vamsi KAVURI, Glen Allen, VA (US)

(73) Assignee: Capital One Services, LLC, McLean, VA (US)

(21) Appl. No.: 18/232,006

(22) Filed: Aug. 9, 2023

(51) Int. Cl. G06Q 10/1093

(52) U.S. Cl. CPC G06Q 10/1093

(57) ABSTRACT

A system and method for automatically generating a calendar of events for a user is disclosed. Events may be associated with one or merchants and may or may not be known to the user. The system identifies events based on user activity, such as purchase or other transactions with a merchant. Events may be obtained in a variety of different methods including by being provided by the merchants that subscribe to the service, or from a scraping operation that scrapes websites and other publicly-available information related to the different merchants. Then, based on the user activity, relevant events from among those known to the automatic calendaring service are identified. Those events are then added to a calendar associated with the user. In embodiments, notification messages are sent to the user to notify them of the changes to the calendar and/or to obtain consent/authorization for the changes.

### TECHNICAL FIELD

Embodiments of the present disclosure are related to automatically generating a calendar of events of interest, and specifically to identifying potential events of interest from one or more transactions, identifying the same or similar events from the same or similar entities, and generating the calendar for the user.

### BACKGROUND

Traditionally, calendaring programs have been limited to storing and displaying events manually entered by individuals. In other words, calendaring programs receive inputs from an individual to establish a particular event within the calendar. Thus, calendar events created by the user are limited to those that the user already knows of. Therefore, the user must be made aware of these events outside of the calendaring program, such as by actively monitoring company websites. As such, calendars generated by these calendaring programs may be incomplete, inaccurate, or reflect out of date information. Additionally, the information may be provided in inconsistent formats, hindering ease of use and searchability.

### BRIEF DESCRIPTION OF THE DRAWINGS/FIGURES

The accompanying drawings are incorporated herein and form a part of the specification.

FIG. 1 illustrates an example automatic calendaring environment according to embodiments.

FIG. 2 illustrates a block diagram of an example automatic calendaring system according to various embodiments.

FIG. 3 illustrates a flowchart diagram of an example automatic calendaring method according to various embodiments.

FIG. 4 illustrates a flowchart diagram of an example data retrieval method for use with the automatic calendaring system according to various embodiments.

FIG. 5 illustrates an example computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are method, system, and computer program product embodiments, and/or combinations and sub-combinations thereof for automatically generating a calendar of potential events of interest.

Traditionally, calendaring programs are limited to storing and displaying events manually entered by individuals. In other words, calendaring programs receive inputs from an individual to establish a particular event within the calendar. Thus, calendar events created by the user are limited to those that the user already knows of. Therefore, the user must be made aware of these events outside of the calendaring program, such as by actively monitoring company websites.

Therefore, there is a need for a system that can automatically identify potential events of interest to a particular user. There is a further need for a mechanism to notify the user of those events, such as through an automatically generated calendar. In order to support these features, a system must be further capable of obtaining, searching for, or otherwise acquiring the necessary event data. These and other aspects will be described in further detail below with respect to the relevant figures.

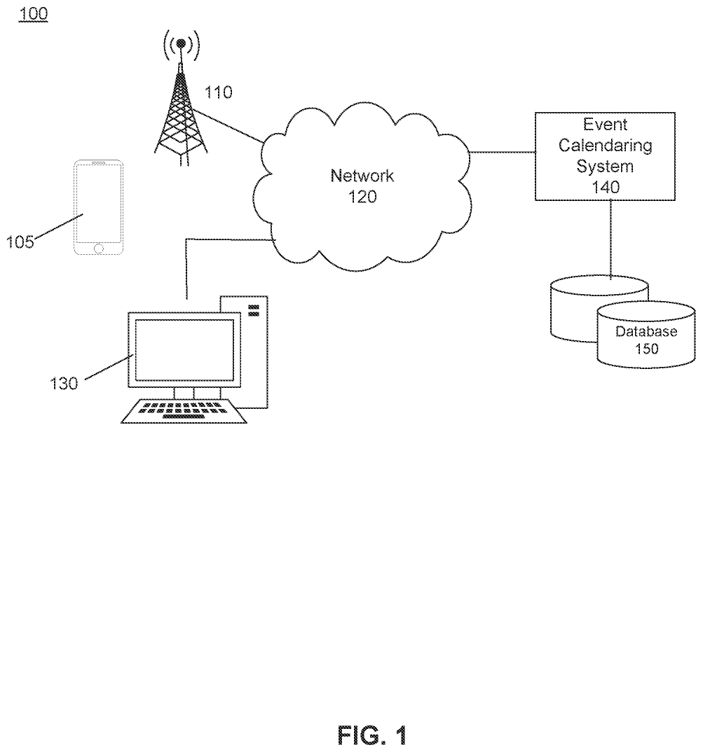

FIG. 1 illustrates an example automatic calendaring environment 100 according to embodiments. As shown in FIG. 1, the environment 100 includes an event calendaring system 140 connected to various end user devices via a network 120. In an embodiment, the network 120 may be any communication network suitable for allowing the exchange of electronic and/or digital communications between the event calendaring system 140 and the various end user devices. In embodiments, the network 120 may be any of a local area network (LAN), a wide area network (WAN), a virtual private network (VPN), a public switched telephone network (PSTN), etc. Additionally, the network may employ communication protocol including any of TCP/IP, SSL, HTTP, etc.

The end user devices may include any number of wired or wireless communication devices capable of interfacing with and communicating over the network 120. Such devices may include one or more cellular devices 105 connected to the network via one or more cellular base stations 110, one or more computer devices 130, and other user devices. A user that participates in the automatic calendaring program can use an end user device to receive event notifications, review and edit event preferences, opt in or out of various event subscriptions, and other actions.

In embodiments, a user of the automatic calendaring service may receive enrollment notifications pertaining to a particular event or merchant. For example, the user can use the one or more computer devices to enroll in, disenroll in, and confirm or decline enrollment in automatic calendaring. For example, in some instances, the event calendaring system 140 may automatically, using one or more algorithms or processes, select the user for automatic calendaring. When this occurs, the system 140 sends a notification to the user via their end user devices requesting authorization for enrollment. Using the end user devices, the user can accept or decline the invitation.

In other embodiments, the user manually requests enrollment in the automatic calendaring service. In this case, the user may use one of the end user devices to access a website, portal or other access mechanism to request enrollment in the service.

In further embodiments, the user that is already enrolled in the automatic calendaring service may receive one or more updates regarding events or merchants that are being added to the user's calendar. Such updates may include a notification that an event is being added to the user's calendar, a notification that a merchant is being added to the user's calendar (e.g., future events associated with the merchant will be automatically added to the user's calendar), or other updates. In embodiments, the update notifications include information about what is being changed on the user's calendar as well as a confirmation request asking the user to authorize or decline the change. Through a user interface of the computer devices 105 and/or 130, the user can reply to the notification message.

The event calendaring system 140 receives information relating to user behavior or transactions, and uses the information to identify events for adding to the user's custom calendar. Such information may be received, for example, from one or more financial transactions such as a credit card transaction. When a credit card transaction is received by the event calendaring system 140, the transaction information includes one or more pieces of information relating to the exchange, including, for example and without limitation, purchase location, purchase amount, purchase data, merchant name or ID, etc., and can sometimes include ever further information such as the specific items or categories of items purchased. From this data, the event calendaring system 140 identifies events that may be of interest to the user, as will be discussed in further detail below.

The event calendaring system 140 is connected to one or more databases 150. The databases store event data associated with different merchants as well as calendar data relating to different customers. For example, the database 150 may include events provided by, or scraped from, different merchants. Such events may include various details about themselves, such as date/time, event title, target demographic, etc. Additionally, the database 150 may also include the various calendars of different users subscribed to the service. Such calendar data may include a user's current events, event authorizations and declines, user interests, etc. In embodiments, certain user transaction data may also be stored relating to different users.

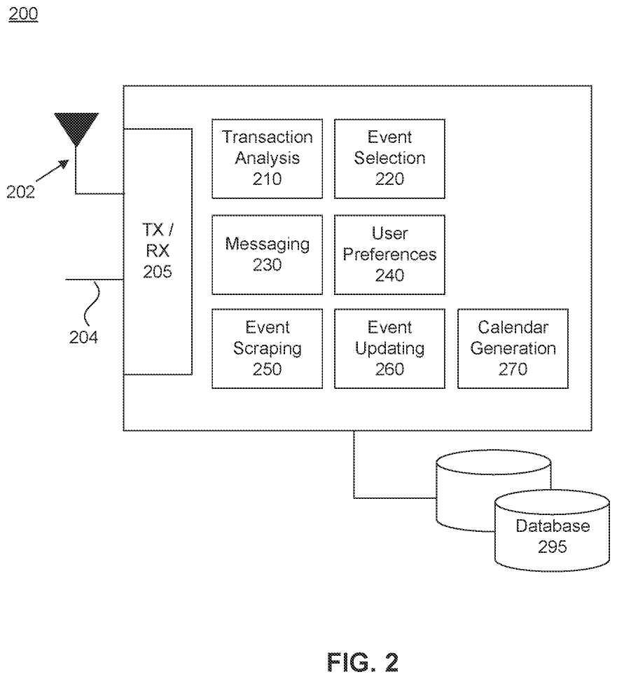

FIG. 2 illustrates a block diagram of an example automatic calendaring system 200 according to various embodiments. As shown in FIG. 2, the automatic calendaring system 200 includes a transceiver 205 for sending and receiving communications with a user, a user device, and/or one or more merchant systems or websites. The transceiver 205 may communicate with external devices over a network, such as network 120, using one or more communication methods and/or protocols. In some embodiments, the transceiver 205 may communicate wirelessly over the network using antenna 202, whereas in other embodiments the transceiver communicates over a wired connection via a cable or other communication line 204.

The automatic calendaring system 200 also includes several functional blocks 210-270. In embodiments, the blocks 210-270 are carried out by one or more processors executing computer instructions stored in memory. The functional blocks include a transaction analysis 210, event selection 220, messaging 230, user preferences 240, event scraping 250, event updating 260, and calendar generation 270. In an embodiment, the automatic calendaring system 200 is operated by a banking, credit or other financial institution responsible for processing user transactions.

Together, the event scraping 250 and event updating 260 operate to maintain an up-to-date database 295 of events. Specifically, event scraping 250 may periodically perform a scraping operation of one or more external sources, such as merchant websites, local event databases, publications, etc. in order to locate and extract relevant event data. Such data may be found from publicly available sources, such as websites, or from private sources specifically set up by a subscribing merchant for the purposes of providing event data to the system 200. The scraping operation can be performed according to known scraping techniques.

Event updating 260 performs updates to the event database 295 when new or changed event information is acquired. In some embodiments, this information is obtained through the scraping operations of event scraping 250 or can be directly provided by subscribing merchants. Event updating 260 receives the event information and updates the database 295. In instances of new event information, the information is added to the database 295 for future calendaring. Meanwhile, in instances of updated event information, existing database entries are revised according to the updates. In this manner, the event database 295 is kept current to allow for accurate calendaring.

Transaction analysis 210 receives and analyzes transactions associated with the user. As discussed above, when a user completes a transaction, such as the purchase of goods or services, a transaction record is generated at the site of the transaction. In embodiments, this applies only to electronic transactions, such as a credit card or bank transaction. The transaction record is received at the transaction analysis 210, which analyzes the information included in the transaction record. In embodiments, the transaction records are received directly from the merchant, from a bank or credit institution handing the transaction, or from a third-party database. In an example embodiment, the automatic calendaring system 200 is operated by a credit card or banking institution that processes the customer's transactions. During this process, this institution is automatically made aware of the transaction so as to follow through with payment to the merchant and billing to the customer. Therefore, the transaction information is stored in a transaction database (not shown) for access and/or retrieval by the automatic calendaring system 200, or is otherwise provided to the automatic calendaring system 200. As discussed above, the transaction record may include several pieces of information relevant to the calendaring operation, including transaction date, location, merchant name, items/services purchased, etc. The transaction analysis extracts this information and uses it to identify pertinent information for selecting relevant events for the user.

Event selection 220 uses the information extracted from the transaction record by the transaction analysis 210 to identify one or more events for the user. For example, based on a merchant ID extracted from the transaction record, the event selection 220 first selects the same or similar merchants for event searching. In embodiments, similar merchants may be identified based on a similarity to the identified merchant by one or more of, for example, types of goods sold, location, target customers, etc. Event selection 220 may further narrow this search based on the transaction location so as to only find events near to the user's original purchase. Event selection 220 may further narrow the search based on whether any events occurred on the date of the original transaction, so as to locate similar events. For example, if the user made a purchase from a merchant that was hosting a children's event on that date, then the search may be narrowed to other children's events at the same or similar merchants and/or locations.

Other data may likewise be used to adjust or narrow the event search. For example, the purchased items may be used to identify stores with similar items or events related to the purchased item (e.g., a builders workshop for a purchase of lumber, etc.), a purchase amount to identify bulk sales or other clearance events, etc.

Once the event selection 220 has identified one or more events and/or merchants to be added to the user's calendar, messaging 230 communicates with a device associated with the user to either confirm or inform the user of the calendar changes. In an embodiment, messaging 230 sends a notification message to the user that notifies the user of the change, including that an event or merchant was added to or removed from the user's calendar. In different embodiments, the notification message may be, for example, an SMS text message transmitted to an end user device associated with the user, an in-app message transmitted to a companion app running on the end user device, an email, etc. In other embodiments, messaging 230 sends a confirmation request to the user in response to the update. Specifically, the message to the user may notify the user of a proposed change to the user's calendar and request authorization from the user to implement the change. In embodiments, messaging 230 can send additional messages, such as event reminders, summary messages summarizing events attended and/or upcoming, and setup messages.

During the setup process, the messaging 230 communicates with the user via transceiver 205 to perform initial account setup. During the setup process, and throughout operation of the automatic calendaring, user preferences may be obtained either directly from the user or inferred based on user activity. Such preferences may include types of events preferred or disliked by the user, specific merchants preferred or disliked by the user, convenient days/times, etc. These user preferences are stored and/or managed by user preferences 240.

Based on the user's preferences, and the user's responses to the messages, calendar generation 270 generates the user's calendar, or updates an existing user calendar associated with the user, to include events identified by event selection and confirmed by or notified to the user. In embodiments, event data added to the user's calendar include, for example and without limitation, one or more of event description, event location, date/time of event, a link to the merchant or event website, related events, etc. The calendar is maintained by the system 200 in a digital format either locally or in one or more remote databases.

In some embodiments, a digital calendar can be printed for the user, such as for including with the user's monthly bill. A user accessing the system digitally via the network 120 may be provided access to the digital calendar for purposes of viewing/editing the contents of the calendar, such as removing events, highlighting or emphasizing events, writing a review of an event or scoring the event, etc.

As described above, in some embodiments, the user's calendar is kept and maintained by the system 200. The user is provided access to the calendar, and may even be given rights to edit the calendar, but the user does not “own” the calendar. However, in other embodiments, the calendar can be a shared calendar owned/maintained by the user, such as a Google Calendar. In this embodiment, the calendar generated by the system 200 can be provided to the user in a variety of different ways, such as through the dynamic generation of an “icalendar” formatted file accessible from a web server. This file format for specifying calendar data is a public standard. Google Calendar, as well as other common publicly-available calendars are capable of importing and displaying ical file formats. In another embodiment, the user may provide an address, link or other location identifier to the service of the online Calendar. Through messaging 230 or other mechanism, the user receives a share identity associated with the system, and provides shared access to the service 200. In this embodiment, after calendar generating 270 generates the list of information to be included within the user's calendar, the calendar generation 270 updates the shared calendar owned/maintained by the user.

In some embodiments, and particularly when the calendar is generated by the system 200 and sent to the user in a well-recognized format, users have the capability of sharing and/or combining their calendars with others, such as friends and family. For example, the system 200 could store the calendar on the web in a manner that is accessible by those with permission. The calendar could then be downloaded by permitted members. Alternatively, the user could forward the calendar file to desired individuals. This can be done using a web interface, a web messaging service (e.g., email), or through other means, such as Bluetooth, SMS text messaging, etc. Recipients of the calendar could then maintain it as a separate calendar or merge it with their own calendar(s).

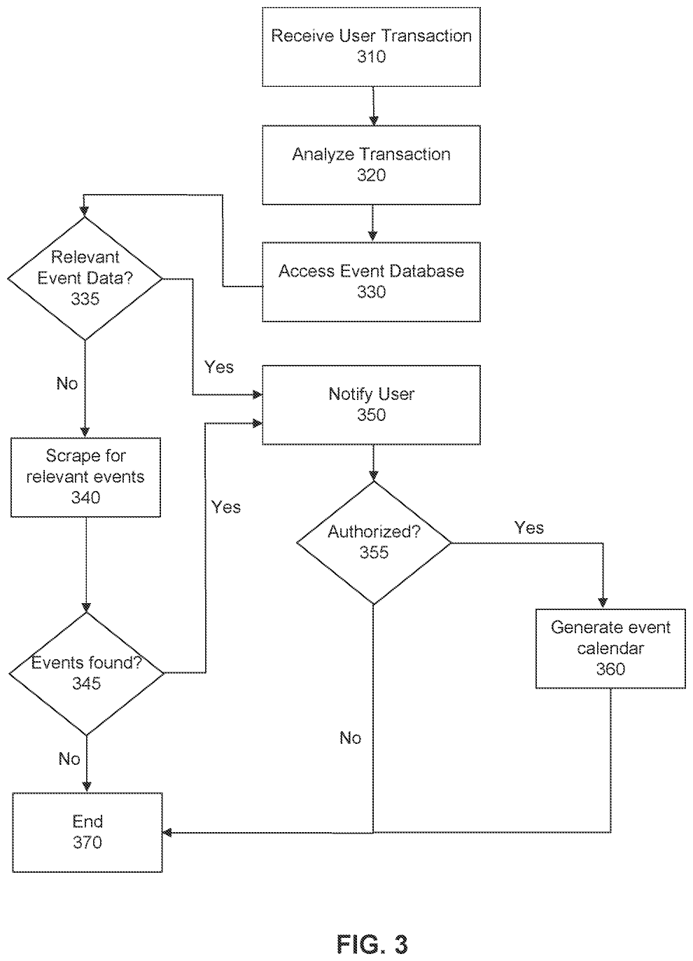

FIG. 3 illustrates a flowchart diagram of an example automatic calendaring method 300 according to various embodiments. As shown in FIG. 3, the method begins at step 310 by the system receiving a user transaction. In an embodiment, the transaction is a financial or credit transaction, such as a credit card purchase of goods. The transaction may include one or more pieces of transaction data, such as merchant, purchase location, purchased items, transaction amount, etc.

In step 320, the transaction is analyzed. In embodiments, the analysis includes extracting the different pieces of transaction information from the received transaction data. In some embodiments, the analysis may require further steps in order to properly identify certain pieces of the transaction information. For example, many transactions may include codes, shorthands, notations, or identifiers rather than full names for various items like merchant names. In this embodiment, the shorthand is extracted and then the analysis carries out a process in order to identify the true identity of the entity corresponding to the shorthand. In some instances, this may be performed by comparing the extracted shorthand to a lookup table. However, in other embodiments, machine learning may be used in order to perform an algorithmic determination of a likely merchant based on a merchant ID, or of another entity based on a shorthand thereof.

In step 330, an event database is accessed. In an embodiment, the event database stores a listing of one or more events associated with all subscribing or scraped merchants. In some embodiments, the event database may store all known events associated with a given merchant, or may store events occurring or scheduled to occur within a given timeframe (such as within the next month). The database may be organized by merchant, location, date, etc. and may include, for each such event, one or a variety of data, including event date, location, type, etc.

In step 335, a determination is made as to whether there exists any relevant event data stored in the event database. Such event data may be considered relevant based on being associated with a merchant from which a transaction was made, being related to goods purchased by the user, within a same or nearby location, etc. Many factors may be considered together when determining whether event data is relevant to the user, as discussed above.

If it is determined that there is relevant event data in the database (335—Yes), then them method 300 proceeds to step 350. In step 350, the user is notified of the relevant data and informed of the intent to add the data to the user's calendar. In some embodiments, the notification may be a message transmitted to a user device associated with the user, and include a request for authorization to make the proposed change, or a link or instructions for declining the proposed change.

Alternatively, if it is determined in step 335 that there is no relevant event data (335—No), then the method 300 proceeds to step 340. In step 340, the system performs a scraping operation for relevant events. In embodiments, the scraping operation accesses and scans one or more databases, websites, or other online sources associated with different merchants. Depending on implementation, the merchants may or may not subscribe to the service. The scan seeks out event information in a variety of different formats based on known or expected formats, etc. Any events are then retrieved, cataloged, and stored in one or more databases. In some embodiments, the system performs a scraping operation for one or more merchants even if relevant event data already exists in the database.

In step 345, a determination is made as to whether any events were found, and whether they are considered relevant to the particular user. If no events or no relevant events were found (345—No), then the method ends in step 370. Alternatively, if relevant events were located from the scraping operation (345—Yes), then the method proceeds to step 350, where the user is notified as to the proposed changes, as described above.

In step 355, a determination is made as to whether the user has authorized the proposed change. As previously discussed, authorization may be given on a case-by-case basis based on explicit authorization of the user, or authorization may be presumed for a particular user unless declined by the user. If authorization is not granted by the user (355—No), then the method ends in step 370.

Alternatively, if the user has authorized the proposed change (355—Yes), then the method proceeds to step 360. In step 360, the system generates the event calendar that includes the new events discovered by the service based on the user's transaction. In an embodiment, the event calendar is a digital calendar that is owned and/or maintained by the service, and the user is granted access and/or editorial rights to the calendar through an online user interface. In other embodiments, generating the event calendar 360 involves modifying a calendar owned/maintained by the user to which the service is granted access and editing rights. After the calendar has been generated in step 360, the method ends in step 370.

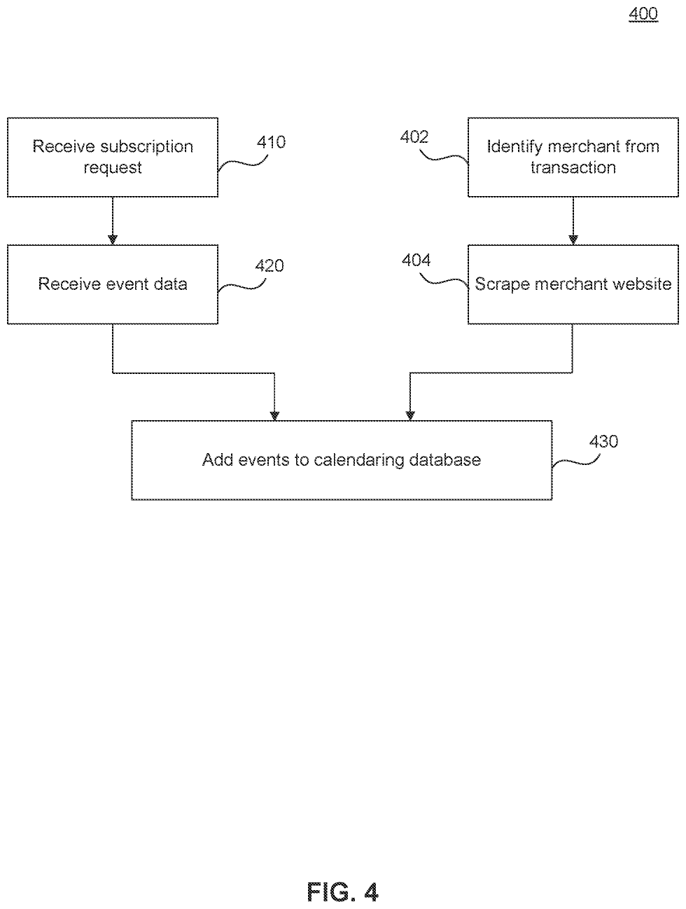

FIG. 4 illustrates a flowchart diagram of an example data retrieval method 400 for use with the automatic calendaring system according to various embodiments. In the example method 400, there may be multiple different means for obtaining event information from merchants, including additional means not shown in FIG. 4. Those can be performed either separately or together to create a more robust and complete event gathering operation. As shown in FIG. 4, the method 400 includes two different event acquisition means: a scraping operation, and a subscription operation.

Specifically, the method 400 begins at step 410 where the method receives a subscription request from a merchant to subscribe to the event calendaring service. In this manner, a merchant or other entity can voluntarily have their events included in the automatic calendaring service, which may increase foot/click traffic (e.g., increased in-store or online patronage) and overall revenue. It also allows the merchant to provide the service with a full and complete listing of events, as well as control event descriptions and other aspects.

Once the subscription has been configured and completed, the method receives event data from the merchant 420. As discussed above, the event data may include one or more items of description relating to one or more events, including date, location, type, target age or other demographic, etc.

Meanwhile, in step 402, the method also performs an automated event data acquisition process. Specifically, the method 400 receives a transaction record from the user or merchant that includes several pieces of information relating to the transaction. In step 402, this information is extracted from the transaction record, and deciphered to identify the various individual pieces of information.

In step 404, using the information obtained in step 402, the system carries out a scraping operation of one or more websites, databases, or other publicly-available sources of event data. In an embodiment, the scraping operation scans for events looking for predefined formats, words, phrases, or other identifiers.

The event data received from the subscribing merchants, as well as the event data obtained through the scraping operation is then added to the database in step 430. In embodiments, the database can be organized according to merchant, location, event type, or other event fields. In some embodiments, the database is updated to replace or change existing entries based on new data obtained from the merchant or from the scraping operation.

It should be understood that the order of the steps described above with respect to FIGS. 3 and 4 are in many cases merely for explanation purposes. In many instances, depending on specific implementation/operation, the steps can be rearranged in different orders as needed.

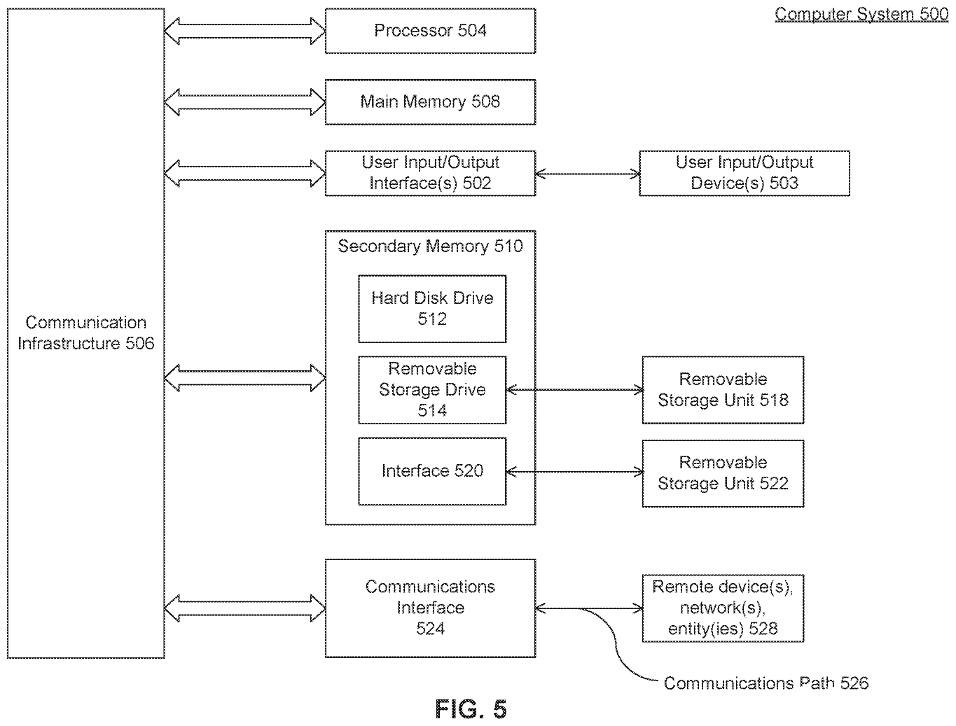

Various embodiments may be implemented, for example, using one or more computer systems, such as computer system 500 shown in FIG. 5. One or more computer systems 500 may be used, for example, to implement any of the embodiments discussed herein, as well as combinations and sub-combinations thereof, by executing instructions corresponding to the embodiments stored in memory.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all example embodiments as contemplated by the inventor(s), and thus, are not intended to limit this disclosure or the appended claims in any way.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described example embodiments, but should be defined only in accordance with the following claims and their equivalents.

What is claimed is:

1. An automated calendaring system, comprising:
a transceiver configured to send and receive messages with a user via a network, the transceiver having a communication interface configured for communicating over a network;
a database that stores activity and event information; and
one or more processors configured to:
analyze the activity data associated with the user;
identify an entity based on the analysis;
retrieve, from the database, potential event information based on the identifying; and
generate a calendar of potential events in response to the retrieving.

2. The automated calendaring system of claim 1, wherein the one or more processors are further configured to:
cause the transceiver to transmit a message to the user over the network confirming enrollment with respect to the entity.

3. The automated calendaring system of claim 2, wherein the message notifies the user of the entity, and requests that the user indicate whether to enroll in automatic calendaring with respect to the entity.

4. The automated calendaring system of claim 2, wherein the message notifies the user of the entity and an intent to automatically enroll the user in automatic calendaring with respect to the entity, and provides an option for the user to disenroll from automatic calendaring with respect to the entity.

5. The automated calendaring system of claim 2, wherein the one or more processors are further configured to:
conduct a query of the data to identify the potential event information;
determine, in response to the database query, that there is no potential event information stored in the database; and
scraping an external electronic source associated with the entity for the potential event information.

6. The automated calendaring system of claim 1, wherein the generated calendar includes the potential event information, and is accessible by the user.

7. The automated calendaring system of claim 1, wherein the one or more processors are further configured to:
cause the transceiver the transmit a request message to the user requesting modification permission from the user to modify an existing digital calendar associated with the user; and
receiving, by the transceiver, a reply message granting the requested permission; and
modifying the user's digital calendar with the potential event information in response to receiving the requested permission.

8. A method for automatically informing a user of events of interest, comprising:
receiving activity data associated with the user;
analyzing the activity data;
detecting, based on the analysis, an entity of interest the user;
searching a database of events for potential event information related to the entity of interest; and
generating a calendar of events relating to the entity of interest in response to the searching.

9. The method of claim 8, wherein the entity of interest is a merchant.

10. The method of claim 8, wherein the activity data is transaction data.

11. The method of claim 8, further comprising:
receiving a request from the user to enroll in automatic calendaring, the request including an identification of the entity of interest.

12. The method of claim 8, further comprising:
transmitting a notification message to the user informing the user of enrollment in automatic calendaring with respect to the entity of interest.

13. The method of claim 12, further comprising:
receiving an opt-out reply from the user in response to the transmitting; and
terminating automatic calendaring in response to the receiving.

14. The method of claim 8, further comprising:
determining no potential event information related to the entity of interest is available in the database;
scraping a plurality of external sources for the potential event information,
wherein the plurality of external sources include a website associated with the entity of interest, and an external database associated with the entity of interest.

15. An automated calendaring system, comprising:
a communication interface configured to exchange data over a network;
a database that stores event information; and
one or more processors configured to:
receive first event information from an entity via the communication interface;
perform a scraping operation with respect to an external source to obtain second event information;
update the database with the first event information and the second event information;
receive activity data associated with a user relating to an interaction with the entity;
enroll the user in automated calendaring with respect to the entity;
retrieve the stored event information associated with the entity; and
generating a customized calendar for the user that includes the event information.

16. The automated calendaring system of claim 15, further comprising receiving an enrollment request from the user,
wherein the enrolling the user in automated calendaring occurs in response to the receiving of the enrollment request.

17. The automated calendaring system of claim 15, wherein the scraping is performed in response to determining that the data base does not include the event information.

18. The automated calendaring system of claim 15, further comprising analyzing the activity data to identify the entity.

19. The automated calendaring system of claim 18, wherein the analyzing further identifies a subset of the stored event information considered relevant to the user.

20. The automated calendaring system of claim 19, wherein the subset is identified based on at least one of a location or an item included in the activity data.
